(19) United States
(12) Patent Application Publication
(10) Pub. No.: US 2023/0384581 A1
(43) Pub. Date: Nov. 30, 2023

(54) PIEZOELECTRICALLY-ACTUATED RESONANT SCANNING MIRROR

(71) Applicant: Microsoft Technology Licensing, LLC, Redmond, WA (US)

(72) Inventors: Xiao Chuan ONG, Bellevue, WA (US); Wyatt Owen DAVIS, Bothell, WA (US)

(73) Assignee: Microsoft Technology Licensing, LLC, Redmond, WA (US)

(21) Appl. No.: 17/804,296

(22) Filed: May 26, 2022

(51) Int. Cl. G02B 26/08; G02B 26/10; G02B 27/01; H02N 2/00

(52) U.S. Cl. CPC G02B 26/0816; G02B 26/10; G02B 27/0172; H02N 2/006; H02N 2/008; G02B 2027/014

(57) ABSTRACT

Examples are disclosed that relate to scanning mirror systems for display devices. One example provides a scanning mirror system comprising a mirror portion, a flexure arm extending from the mirror portion, and a piezoelectric actuator support portion supporting a piezoelectric actuator comprising a piezoelectric film. The scanning mirror system further comprises a transmission arm extending between the flexure arm and the piezoelectric actuator support portion to transmit motion of the piezoelectric film to the flexure arm, the transmission arm separated at least partially from the piezoelectric actuator support portion by a first gap. The scanning mirror system further comprises an anchor portion separated at least partially from the piezoelectric actuator support portion by a second gap, the anchor portion configured to anchor the scanning mirror system to another structure.

### BACKGROUND

A display device may utilize a scanning mirror system to scan light from a light source to produce a viewable image.

### SUMMARY

Examples are disclosed that relate to scanning mirror systems for display devices. One example provides a scanning mirror system comprising a mirror portion, a flexure arm extending from the mirror portion, and a piezoelectric actuator support portion supporting a piezoelectric actuator comprising a piezoelectric film. The scanning mirror system further comprises a transmission arm extending between the flexure arm and the piezoelectric actuator support portion to transmit motion of the piezoelectric film to the flexure arm, the transmission arm separated at least partially from the piezoelectric actuator support portion by a first gap. The scanning mirror system further comprises an anchor portion separated at least partially from the piezoelectric actuator support portion by a second gap, the anchor portion configured to anchor the scanning mirror system to another structure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example head-mounted display device.

FIG. 2 shows a block diagram of an example display device that utilizes a scanning mirror system to form an image.

FIG. 3 shows a front view of an example scanning mirror system.

FIG. 4 shows a back view of the example scanning mirror system of FIG. 3.

FIG. 5 schematically shows a side view of the example scanning mirror system of FIG. 3 mounted to another structure.

FIG. 6 shows a front view of another example scanning mirror system.

FIG. 7 schematically shows a side view of the example scanning mirror system of FIG. 6 mounted to another structure.

FIG. 8 shows a block diagram of an example computing system.

### DETAILED DESCRIPTION

As mentioned above, a display system may utilize a resonant scanning mirror system to scan light from a light source to form an image for display. In a resonant scanning mirror system, light from a light source (e.g., one or more lasers) is scanned in a first direction (e.g. horizontally) at a higher rate by resonant oscillatory motion of the mirror, and a second direction (e.g. vertically) at a lower rate (e.g. at a video frame rate) according to a sawtooth wave-like control signal. Control of the mirror angle, as well as the intensity of light output by each of one or more light sources (e.g. red, green and blue light sources), produces a viewable image.

For applications such as a head-mounted display (HMD) device, in which compact form factor and low-power operation may be design priorities, the size and power consumption of a scanning mirror system may be of concern. For example, space for a scanning mirror system may be limited in a small-form factor HMD. Also, as an untethered HMD may utilize an internal battery, space for a battery also may be limited, thus leading to the use of a relatively smaller battery.

Accordingly, examples are disclosed that relate to resonant scanning mirror systems that may be of suitably small size and may operate at suitably low power for use in relatively smaller display devices, such as HMDs. In one example, a scanning mirror system according to the present disclosure comprises a mirror portion, a flexure arm extending from the mirror portion, and a piezoelectric actuator support portion comprising a piezoelectric actuator to actuate resonant motion of the mirror portion. The scanning mirror system further comprises a transmission arm extending between the flexure arm and the piezoelectric actuator support portion, wherein the transmission arm is separated at least partially from the piezoelectric actuator support portion by a gap. The scanning mirror system further comprises an anchor portion separated at least partially from the piezoelectric actuator support portion by a second gap. The first and second gaps allow the piezoelectric actuator support portion to be configured to match a mode shape of the scanning mirror during resonant oscillation. This may help to reduce mechanical dampening and increase electromechanical coupling, which may allow for relatively lower drive voltages.

Further, the mirror portion may comprise a relatively smaller size and/or smaller scan angle compared to other mirror systems. As such, the scanning mirror system may experience less air damping during resonant oscillatory motion, which may further permit the use of lower drive voltages. The use of lower drive voltages may allow for the use of smaller batteries than current resonant scanning mirror systems. This may help to reduce HMD size and weight. Examples are also disclosed that relate to a transmission arm comprising a segment that is tapered towards the flexure arm. A tapered transmission arm may help to provide for a more compact scanning mirror system while maintaining flexure arm length and transmission arm stiffness.

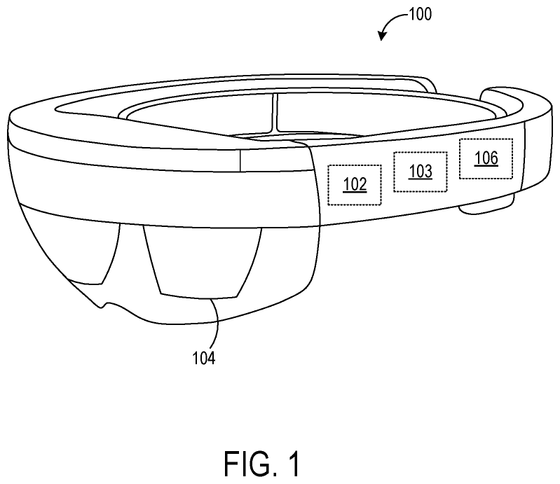

The example scanning mirror systems disclosed may be used in any suitable display device. Examples include HMD devices, other near-eye display devices, picoprojectors, televisions, monitors, and mobile device displays (e.g. smart phones, tablet computers, laptop computers, etc.). FIG. 1 shows an example HMD device 100 that may use a scanning mirror system according to the present disclosure. HMD device 100 includes a display system configured to display near-eye imagery to a wearer. For example, HMD device 100 comprises a scanning mirror system 102 configured to scan light from a light source 103 to form virtual imagery that is delivered to a user's eye via one or more optics, including a waveguide 104 configured to combine projected imagery from the scanning mirror system 102 with a view of a real-world background. Light source 103 comprises one or more lasers configured to direct light toward scanning mirror system 102.

HMD device 100 also comprises a computing device 106 configured to perform various computing functions, including but not limited to generating virtual imagery by controlling scanning mirror system 102 and light source 103. Computing device 106 may include any suitable computing hardware, such as a logic subsystem (e.g. including a processor) and a storage subsystem. The logic subsystem may be configured to execute instructions stored on the storage subsystem to implement any suitable computing functions. Example computing system hardware is described in more detail below with reference to FIG. 8. In other examples, at least some computing functions may be performed off-board. Further, in some examples, HMD device 100 comprises separate scanning mirror systems, light sources, and/or projection optics for each eye. Additionally, in other examples, an HMD that may use a scanning mirror system according to the present disclosure may comprise a form factor similar to eyeglasses.

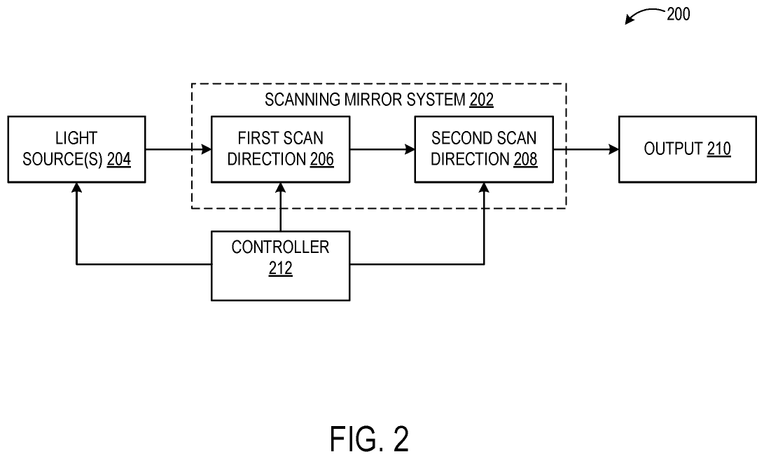

FIG. 2 shows a block diagram of an example display device 200 including a scanning mirror system 202. HMD device 100 is an example of display device 200. Display device 200 includes one or more light sources 204, (e.g., lasers) that output light to scanning mirror system 202. Scanning mirror system 202 is configured to scan the light in a first scan direction 206 (e.g., horizontally) at a higher, resonant scanning frequency and in a second scan direction 208 (e.g., vertically) at a lower scanning frequency, such as at a video frame rate. Scanning mirror system 202 may include a single mirror driven in both horizontal and vertical directions, or two mirrors separately driven in horizontal and vertical directions. The resulting image is provided to an output 210 for display. Output 210 may take any suitable form, such as a display surface, projection optics, or waveguide optics, as examples. Display device 200 may be configured as a virtual reality head-mounted display (HMD) device configured to present a fully immersive experience, or as an augmented reality HMD device configured to combine projected virtual imagery with a view of the surrounding real-world environment. The display device 200 further comprises a controller 212 configured to control operation of light source(s) 204, scanning mirror system 202 and other device components.

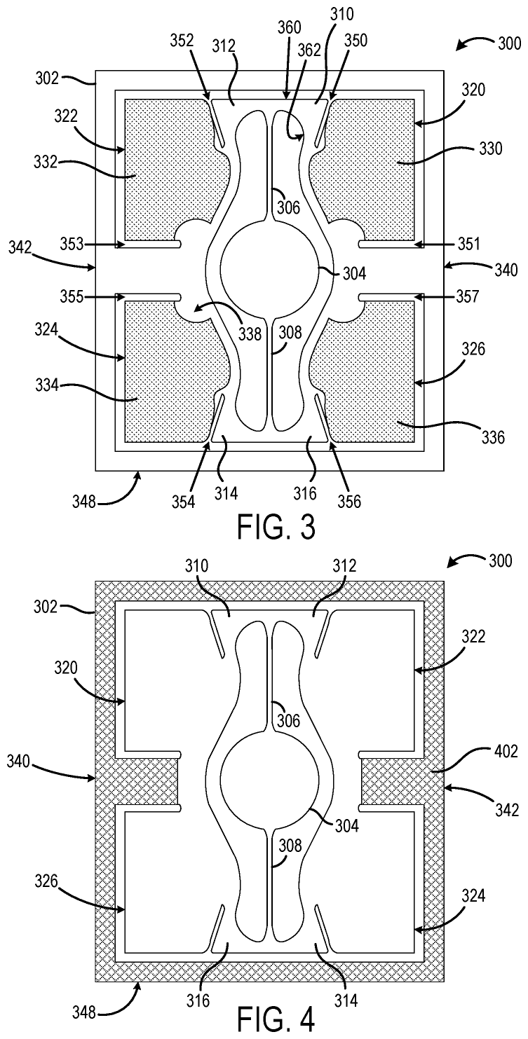

FIGS. 3-5 show an example scanning mirror system 300 controllable to vary an angle at which light from a light source (e.g., light source 204) is reflected to thereby form a displayed image. Aspects of scanning mirror system 300 may be implemented in scanning mirror system 102 of HMD device 100 and/or scanning mirror system 202, for example.

Scanning mirror system 300 comprises a body 302 comprising a mirror portion 304 supported by flexure arms 306, 308. Body 302 further comprises transmission arms 310 and 312 that connect to flexure arm 306, and transmission arms 314 and 316 that connect to flexure arm 308. Body 302 further comprises piezoelectric actuator support portions 320, 322, 324, 326, each supporting a piezoelectric film and electrodes of respective piezoelectric actuators 330, 332, 334, 336. The piezoelectric actuators 330, 332, 334, 336 can be energized by conductors (not shown) that connect to the electrodes to cause conformation of the piezoelectric films, thereby causing mechanical motion of resonant scanning mirror system 300. The piezoelectric films of the piezoelectric actuators 330, 332, 334 and 336 comprise a cutout profile, as indicated at 338 on piezoelectric actuator 334. The term “cutout profile” is used herein to represent a portion of a perimeter that is directed inwardly toward a center of the piezoelectric actuator support portion. Each cutout profile may be shaped based upon modeling of stresses that body 302 experiences during mirror oscillation. A cutout profile may help avoid placing a piezoelectric film on regions of body 302 at which stresses on the piezoelectric film would exceed the yield stress of the piezoelectric film during mirror oscillation, and also may help reduce mechanical dampening of mirror motion. In other examples, such a cutout profile may be omitted.

In the example of FIG. 3, body 302 comprises anchor portions 340, 342 and a frame portion 348 configured to anchor scanning mirror system 300 to another structure, such as a circuit board. In other examples, frame portion 348 may be omitted, as described below.

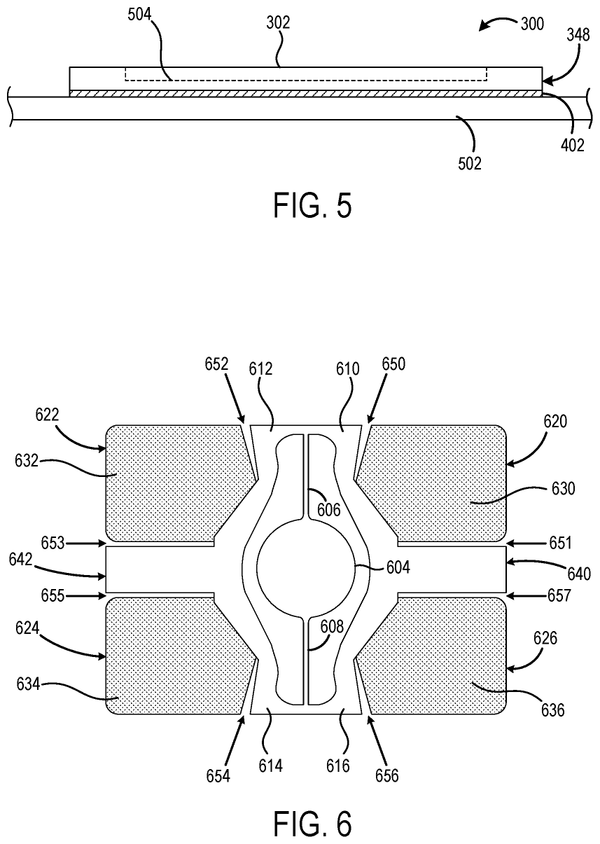

FIG. 4 depicts a bottom view of scanning mirror system 300, showing an adhesive 402 that bonds anchor portions 340 and 342 and frame portion 348 to an underlying structure. FIG. 5 shows a side view of scanning mirror system 300 mounted on a circuit board 502 via adhesive 402. Anchor portions 340 and 342 and frame portion 348 comprise a thicker profile than the rest of body 302, as indicated by dashed line 504 representing the bottom surface of other portions of body 302. This provides mirror portion 304 with vertical relief to accommodate resonant scanning oscillation.

Body 302 may be formed from any suitable material. In some examples, body 302 may be formed by etching a semiconductor wafer, such as a silicon/silicon oxide/silicon multilayer wafer. In such a structure, the mirror portion 304, piezoelectric actuator support portions 320, 322, 324, 326, flexure arms 306, 308, transmission arms 310, 312, 314, 316, and other components (e.g. strain sensors, conductors for energizing the piezoelectric actuators) are formed in an upper layer, referred to as a device layer. The other silicon layer, separated by the oxide layer from the device layer, may be referred to as a handle layer, and may be removed from most regions other than anchor regions and/or frame of body 302. In some examples, the device layer may be approximately 300 μm thick, the oxide layer may be approximately 1 μm thick, and the handle layer may be between 300-450 μm. A thickness profile of body 302 may be configured to control dynamic deformation of the resonant scanning mirror during scanning to maintain desired strain characteristics. The thickness profile also may be configured to achieve a desired mode shape to drive resonant mirror motion.

As depicted in FIG. 3, the piezoelectric actuator support portions are at least partially separated from transmission arms and anchor portions by gaps. For example, transmission arm 310 is at least partially separated from piezoelectric actuator support portion 320 by gap 350. Further, anchor portion 340 is at least partially separated from piezoelectric actuator support portion 320 by gap 351. Likewise, piezoelectric actuator support portion 322 is at least partially separated from transmission arm 312 by gap 352, and at least partially separated from anchor portion 342 by gap 353. Continuing, piezoelectric actuator support portion 324 is at least partially separated from transmission arm 314 by gap 354, and at least partially separated from anchor portion 342 by gap 355. Further, piezoelectric actuator support portion 326 is at least partially separated from transmission arm 316 by gap 356, and at least partially separated from anchor portion 340 by gap 357. Gaps 350, 351, 352, 353, 354, 355, 356, 357 are directed inwardly from an outer perimeter of scanning mirror system 300.

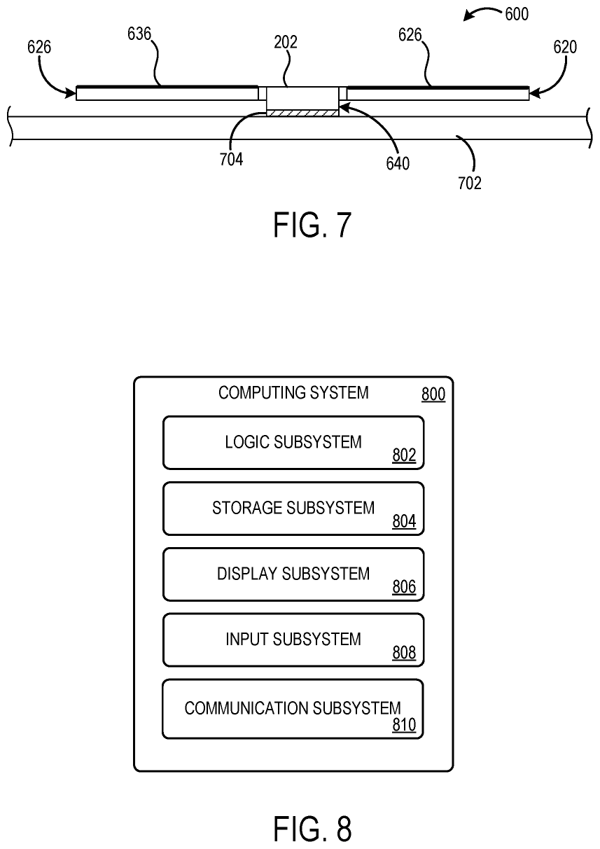

In the example depicted in FIG. 3, gaps 350, 351, 352, 353, 354, 355, 356, 357 comprise linear slits having relatively uniform width. In other examples, a gap comprising any other suitable shape may be used. FIGS. 6-7 shows an example scanning mirror system 600 that includes gaps comprising tapered slits. More particularly, scanning mirror system 600 comprises a body 602 comprising a mirror portion 604 supported by flexure arms 606, 608. Body 602 further comprises transmission arms 610 and 612 that connect to flexure arm 606, and transmission arms 614 and 616 that connect to flexure arm 608. Body 602 further comprises piezoelectric actuator support portions 620, 622, 624, 626 each supporting a piezoelectric film and electrodes of a respective piezoelectric actuator 630, 632, 634, 636. Piezoelectric actuator support portions 620, 622, 624, 626 are at least partially separated from transmission arms 610, 612, 614, 616 and anchor portions 640, 642 by gaps 650, 651, 652, 653, 654, 655, 656, and 657 in body 602. As depicted in FIG. 6, gaps 650, 652, 654, and 656 each comprise a tapered slit. Gaps 650, 651, 652, 653, 654, 655, 656, and 657 are directed inwardly from an outer perimeter of scanning mirror system 600. In other examples, gaps in a scanning mirror system according to the present disclosure may have any other suitable configuration.

Scanning mirror system 600 omits the frame of scanning mirror system 300. As such, body 602 is configured to be mounted to another structure via adhesives at anchor portions 640, 642. This may allow for a greater magnitude of motion of the piezoelectric actuator support portions during operation, which may provide for less dampening and lower power operation. FIG. 7 schematically shows a side view of scanning mirror system 600 mounted on a circuit board 702 via adhesive 704. Anchor portions 640 and 642 comprise a thicker profile than the rest of body 602 (e.g., piezoelectric actuator support portions 620 and 626).

Returning to FIG. 3, as mentioned above, each piezoelectric actuator 330, 332, 334, and 336 comprises a piezoelectric film disposed between a pair of electrodes. The piezoelectric film of each of piezoelectric actuator 330, 332, 334, and 336 converts electrical energy to mechanical energy. When suitable voltages are applied across each of the piezoelectric thin films via the electrodes, the lattice changes experienced by the piezoelectric film cause body 302 to deform, thereby tilting mirror portion 304. Transmission arms 310, 312 transmit motion from respective piezoelectric actuator support portions 320, 322 to flexure arm 306. Likewise, transmission arms 314, 316 transmit motion from respective piezoelectric actuator support portions 324, 326 to flexure arm 308. By modulating the voltages applied to each piezoelectric film of piezoelectric actuators 330, 332, 334, 336 in a suitable phase relationship and at a suitable frequency, resonant oscillation of the mirror portion 304 may be achieved.

At a resonant frequency, body 302 may deform according to a vibrational mode of the body. Thus, as mentioned above, a perimeter of piezoelectric films of piezoelectric actuators 330, 332, 334, 336 follow a contour of a mode shape of body 302 during resonant oscillation. This may help to prevent dampening of the movement of body 302 and/or increase electromechanical coupling, and thereby may allow the mirror to be driven with lower power than other resonant mirror systems. The mode shape of body 302 may be determined at least in part by a shape and/or stiffness of piezoelectric actuator support portions 320, 322, 324, 326, which is influenced by gaps 350, 351, 352, 353, 354, 355, 356, 357. The use of gaps 351, 353, 355, 357 between piezoelectric actuator support portions and corresponding anchor portions 340, 342 may help to lessen dampening of the motion of body 302 and also improve electromechanical coupling during use compared to resonant mirror systems that do not include such gaps. Less damping may allow for use of lower drive voltages to operate scanning mirror system 300, which may help to reduce power consumption.

A scanning mirror system may experience air damping when the scanning mirror is oscillating. In some examples, air damping may be alleviated by hermetically sealing the scanning mirror system. However, hermetic sealing may add cost. Thus, in other examples, scanning mirror system 300 may achieve less air damping by using a relatively smaller mirror compared to other scanning mirror systems. In some examples, the mirror portion may comprise a width within a range of 1.0 mm to 5.0 mm, a range of 1.4 mm to 1.8 mm, a range of 1.4 mm to 1.6 mm, or a range of 1.45 mm to 1.55 mm. In some examples, the mirror portion may comprise an area within a range of 1.0 mm² to 25 mm², a range of 1.5 mm² to 2.5 mm², a range of 1.5 mm² to 2.0 mm², or a range of 1.5 mm² to 1.8 mm². In other examples, values outside these ranges also may be used.

During resonant oscillation, mirror portion 304 rotates, causing torsional strain in flexure arms 306, 308. Torsional strain may be greater for larger scan angles and/or shorter flexure length. As such, scanning mirror system 300 comprises features that help achieve a suitable flexure length while maintaining stiffness. Maintaining stiffness is helpful to achieve better transmission of mechanical power from the actuator to the mirror compared to other mirror systems. As shown in FIG. 3, transmission arms 310, 312, 314, 316 comprise segments that are tapered, which may help increase flexure arm length compared to examples without tapered segments. For example, transmission arm 310 is tapered in segment 360 along a direction from piezoelectric actuator support portion 320 towards flexure arm 306. By tapering segment 360, the length of flexure arm 306 is longer compared to examples where segment 360 is not tapered. A longer flexure length may help keep stresses low in flexure arm 306, which may help to improve device reliability. Additionally, longer flexure arms may allow use of wider flexures, which can help improve manufacturability. Furthermore, transmission arm 310 also is tapered in a second segment 362 along a direction from flexure arm 306 towards piezoelectric actuator support portion 320. Tapering segments of the transmission arms may help maintain stiffness of the transmission arm compared to examples with thin transmission arms of constant width. In other examples, tapering of one or more segments may be omitted.

In some examples, a scanning mirror system may comprise a relatively smaller scan angle to lessen stress in flexure arms. For example, scanning mirror system 300 may comprise a scan angle within a range of 40° to 60°, 40° to 55°, or 40° to 50°. In other examples, a scan angle outside these ranges may be used. For a given device size, decreasing the mirror scan angle may help reduce dynamic deformation in the mirror when the mirror is oscillating and improve device reliability. Further, a relatively smaller scan angle may help reduce power loss due to air damping. For a given stress limit and drive voltage, an overall size of the scanning mirror system may be reduced if the scan angle is reduced. As such, use of a lower scan angle may help achieve a more compact scanning mirror system.

As discussed above, smaller mirror sizes also may help reduce device size. In some examples, the scanning mirror system may comprise a length within a range of 5.0 mm to 6.5 mm and a width within a range of 5.0 mm to 7.2 mm. In other examples, a scanning mirror system may comprise a size outside of these ranges. By omitting a frame, as in scanning mirror system 600, further size reductions may be achieved.

By avoiding power loss due to damping, scanning mirror system 300 may provide for a relatively high Q factor (quality factor) compared to other designs. The Q factor of a system is proportional to a ratio of energy stored in the system to the energy dissipated per cycle, defined as:

$$Q ≡ 2 π \frac{energy stored}{energy dissipated per cycle} .$$

In some examples, scanning mirror system 300 comprises an estimated Q factor of approximately 2300. Additionally, in some examples, scanning mirror system 600 comprises an estimated Q factor of approximately 2000. Estimated Q factors are derived from simulated performance data. In other examples, a scanning mirror system may comprise a Q factor within a range of 1100 to 25,000. In some such examples, the Q factor may be greater than 1800, greater than 3000, or even greater than 10,000. As discussed above, hermetically sealing the scanning mirror system may lower air damping and provide a greater Q factor compared to systems that are not hermetically sealed. In other examples, a scanning mirror system may have a Q factor value outside of these ranges.

Lowering damping and providing a higher Q factor may allow for lower drive voltages and lower power consumption. For example, as less power is lost per cycle due to damping, the power input into the system may also be less. Further, as described above, gaps 350, 351, 352, 353, 354, 355, 356, 357 (and corresponding gaps in resonant mirror system 600) provide for relatively flexible piezoelectric actuator support portions 320, 322, 324, 326, which may allow for lower drive voltages. In some examples, a drive voltage may be within a range of 5 V to 15 V. In other examples, a drive voltage outside of this range may be used. Additionally, in some examples, a resonant frequency of a scanning mirror system may comprise a frequency within a range of 20 to 30 kHz. As one more specific example, scanning mirror system 300 may be configured to operate at a frequency of approximately 28 kHz and a drive voltage of approximately 9.8 V. As another more specific example, scanning mirror system 600 may be configured to operate at 21 kHz and a drive voltage of approximately 6.6 V. In other examples, any other suitable resonance frequency and drive voltage may be employed.

The power consumption of a scanning mirror system is a combination of factors including mechanical power consumption and actuator power consumption. Mechanical power consumption may refer to power loss due to damping. As described above, the mirror portion and the piezoelectric support portions may be configured to reduce damping, and thus reduce mechanical power consumption. As such, the examples disclosed herein may comprise a mechanical power consumption within a range of 3 mW to 10 mW. In more specific examples, simulations estimated a mechanical power consumption of 7.3 mW for a scanning mirror system having a configuration of scanning mirror system 300, and a mechanical power consumption of 3.5 mW for a scanning mirror system having a configuration of example scanning mirror system 600.

Further, as described above, the use of flexible piezoelectric actuator support portions that are separated from other portions by gaps may allow for lower drive voltages. As such, in some examples a resonant scanning mirror system according to the present disclosure may comprise a piezoelectric power consumption within a range of 4 mW to 10 mW. In more specific examples, simulations estimated a piezoelectric power consumption of 7.6 mW for a scanning mirror system having a configuration of example scanning mirror system 300, and a piezoelectric power consumption of 5.6 mW for a scanning mirror system having a configuration of example scanning mirror system 600. Accordingly, a scanning mirror system configured according to the examples disclosed herein may comprise a power consumption within a range of 7 mW to 20 mW. In other examples, power consumption may fall outside these ranges.

Thus, the disclosed examples may provide for reduced damping, improved efficiency, smaller size, and lower power consumption. As such, the disclosed examples may provide for compact, low-power scanning mirror systems that may be incorporated into small form factor display devices.

In some examples, the methods and processes described herein may be tied to a computing system of one or more computing devices. In particular, such methods and processes may be implemented as a computer-application program or service, an application-programming interface (API), a library, and/or other computer-program product.

FIG. 8 schematically shows an example computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices. Computing system 800 may represent HMD device 100 or controller 212, as examples.

Computing system 800 includes a logic subsystem 802 and a storage subsystem 804. Computing system 800 may optionally include a display subsystem 806, input subsystem 808, communication subsystem 810, and/or other components not shown in FIG. 8.

Logic subsystem 802 includes one or more physical devices configured to execute instructions. For example, logic subsystem 802 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic subsystem 802 may include one or more processors configured to execute software instructions. Additionally or alternatively, logic subsystem 802 may include one or more hardware or firmware logic machines configured to execute hardware or firmware instructions. Processors of logic subsystem 802 may be single-core or multi-core, and the instructions executed thereon may be configured for sequential, parallel, and/or distributed processing. Individual components of logic subsystem 802 optionally may be distributed among two or more separate devices, which may be remotely located and/or configured for coordinated processing. Aspects of logic subsystem 802 may be virtualized and executed by remotely accessible, networked computing devices configured in a cloud-computing configuration.

Storage subsystem 804 includes one or more physical devices configured to hold instructions executable by logic subsystem 802 to implement the methods and processes described herein. When such methods and processes are implemented, the state of storage subsystem 804 may be transformed—e.g., to hold different data.

Storage subsystem 804 may include removable and/or built-in devices. Storage subsystem 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 804 may include volatile, nonvolatile, dynamic, static, read/write, read-only, random-access, sequential-access, location-addressable, file-addressable, and/or content-addressable devices.

It will be appreciated that storage subsystem 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 802 and storage subsystem 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 806 may be used to present a visual representation of data held by storage subsystem 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic subsystem 802 and/or storage subsystem 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 800 to send and/or receive messages to and/or from other devices via a network such as the Internet.

Another example provides a scanning mirror system, comprising a mirror portion, a flexure arm extending from the mirror portion, a piezoelectric actuator support portion supporting a piezoelectric actuator comprising a piezoelectric film, a transmission arm extending between the flexure arm and the piezoelectric actuator support portion to transmit motion of the piezoelectric film to the flexure arm, the transmission arm separated at least partially from the piezoelectric actuator support portion by a first gap, and an anchor portion separated at least partially from the piezoelectric actuator support portion by a second gap, the anchor portion configured to anchor the scanning mirror system to another structure. In some such examples, the transmission arm is tapered at least in a first segment along a direction from the piezoelectric actuator support portion towards the flexure arm. In some such examples, the transmission arm additionally or alternatively is tapered in a second segment along a direction from the flexure arm towards the piezoelectric actuator support portion. In some such examples, the mirror portion additionally or alternatively comprises a width within a range of 1 mm to 5 mm. In some such examples, the mirror portion additionally or alternatively comprises an area within a range of 1 mm² to 25 mm². In some such examples, the piezoelectric actuator support portion is a first piezoelectric actuator support portion and the transmission arm is a first transmission arm, and the scanning mirror system additionally or alternatively comprises a second piezoelectric actuator support portion supporting a second piezoelectric film, a second anchor portion, and a second transmission arm extending between the flexure arm and the second piezoelectric actuator support portion to transmit motion of the second piezoelectric film to the flexure arm, the second transmission arm separated at least partially from the second piezoelectric actuator support portion by a third gap and from the second anchor portion by a fourth gap. In some such examples, the flexure arm is a first flexure arm, and the scanning mirror system additionally or alternatively further comprises a second flexure arm extending from the mirror portion opposite the first flexure arm, a third piezoelectric actuator support portion supporting a third piezoelectric film and a fourth piezoelectric actuator support portion supporting a fourth piezoelectric film, a third transmission arm extending between the second flexure arm and third piezoelectric actuator support portion to transmit motion of the third piezoelectric film to the second flexure arm, and a fourth transmission arm extending between the second flexure arm and the fourth piezoelectric actuator support portion to transmit motion of the fourth piezoelectric film to the second flexure arm. In some such examples, the first gap additionally or alternatively comprises a linear slit. In some such examples, the first gap additionally or alternatively comprises a tapered slit. In some such examples, the scanning mirror system additionally or alternatively comprises a Q factor that is greater than 1100 and less than 25,000. In some such examples, the piezoelectric actuator support portion additionally or alternatively is configured to match a mode shape of the mirror portion when the mirror portion is oscillating.

Another example provides a display device, comprising a controller, a light source, and a scanning mirror system comprising a mirror portion, a flexure arm extending from the mirror portion, and a piezoelectric actuator support portion supporting a piezoelectric actuator comprising a piezoelectric film. The scanning mirror system further comprises a transmission arm extending between the flexure arm and the piezoelectric actuator support portion to transmit motion of the piezoelectric film to the flexure arm, the transmission arm separated at least partially from the piezoelectric actuator support portion by a first gap, and an anchor portion separated at least partially from the piezoelectric actuator support portion by a second gap, the anchor portion configured to be joined to an underlying substrate. In some such examples, the transmission arm is tapered at least in a first segment along a direction from the piezoelectric actuator support portion towards the flexure arm. In some such examples, the transmission arm additionally or alternatively is tapered in a second segment along a direction from the flexure arm towards the piezoelectric actuator support portion. In some such examples, the controller additionally or alternatively is configured to energize the piezoelectric film using a drive voltage within a range of 5.0 V to 10.0 V.

Another examples provides a scanning mirror system, comprising a body comprising a mirror portion, a flexure arm extending from the mirror portion, a piezoelectric actuator support portion supporting a piezoelectric actuator comprising a piezoelectric film, a transmission arm extending between the flexure arm and the piezoelectric actuator support portion to transmit motion of the piezoelectric film to the flexure arm, the transmission arm comprising a tapered profile in a first segment extending towards the flexure arm, and an anchor portion separated at least partially from the piezoelectric actuator support portion by a gap, the anchor portion configured to be joined to an underlying substrate. In some such examples, the transmission arm further comprises a tapered profile in a second segment extending towards the piezoelectric actuator support portion. In some such examples the gap is a first gap, and the second segment of the transmission arm additionally or alternatively is at least partially separated from the piezoelectric actuator support portion by a second gap. In some such examples the piezoelectric actuator support portion additionally or alternatively is configured to match a mode shape of the mirror portion when the mirror portion is oscillating. In some such examples the scanning mirror system additionally or alternatively comprises a Q factor that is greater than 1100 and less than 25,000.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A scanning mirror system, comprising:
a mirror portion;
a flexure arm extending from the mirror portion;
a piezoelectric actuator support portion supporting a piezoelectric actuator comprising a piezoelectric film;
a transmission arm extending between the flexure arm and the piezoelectric actuator support portion to transmit motion of the piezoelectric film to the flexure arm, the transmission arm separated at least partially from the piezoelectric actuator support portion by a first gap; and
an anchor portion separated at least partially from the piezoelectric actuator support portion by a second gap, the anchor portion configured to anchor the scanning mirror system to another structure.

2. The scanning mirror system of claim 1, wherein the transmission arm is tapered at least in a first segment along a direction from the piezoelectric actuator support portion towards the flexure arm.

3. The scanning mirror system of claim 2, wherein the transmission arm is tapered in a second segment along a direction from the flexure arm towards the piezoelectric actuator support portion.

4. The scanning mirror system of claim 1, wherein the mirror portion comprises a width within a range of 1 mm to 5 mm.

5. The scanning mirror system of claim 1, wherein the mirror portion comprises an area within a range of 1 mm² to 25 mm².

6. The scanning mirror system of claim 1, wherein the piezoelectric actuator support portion is a first piezoelectric actuator support portion and the transmission arm is a first transmission arm, and further comprising
a second piezoelectric actuator support portion supporting a second piezoelectric film,
a second anchor portion, and
a second transmission arm extending between the flexure arm and the second piezoelectric actuator support portion to transmit motion of the second piezoelectric film to the flexure arm, the second transmission arm separated at least partially from the second piezoelectric actuator support portion by a third gap and from the second anchor portion by a fourth gap.

7. The scanning mirror system of claim 6, wherein the flexure arm is a first flexure arm, and further comprising:
a second flexure arm extending from the mirror portion opposite the first flexure arm,
a third piezoelectric actuator support portion supporting a third piezoelectric film and a fourth piezoelectric actuator support portion supporting a fourth piezoelectric film,
a third transmission arm extending between the second flexure arm and third piezoelectric actuator support portion to transmit motion of the third piezoelectric film to the second flexure arm, and
a fourth transmission arm extending between the second flexure arm and the fourth piezoelectric actuator support portion to transmit motion of the fourth piezoelectric film to the second flexure arm.

8. The scanning mirror system of claim 1, wherein the first gap comprises a linear slit.

9. The scanning mirror system of claim 1, wherein the first gap comprises a tapered slit.

10. The scanning mirror system of claim 1, wherein the scanning mirror system comprises a Q factor that is greater than 1100 and less than 25,000.

11. The scanning mirror system of claim 1, wherein the piezoelectric actuator support portion is configured to match a mode shape of the mirror portion when the mirror portion is oscillating.

12. A display device, comprising:
a controller;
a light source; and
a scanning mirror system comprising
a mirror portion,
a flexure arm extending from the mirror portion,
a piezoelectric actuator support portion supporting a piezoelectric actuator comprising a piezoelectric film,
a transmission arm extending between the flexure arm and the piezoelectric actuator support portion to transmit motion of the piezoelectric film to the flexure arm, the transmission arm separated at least partially from the piezoelectric actuator support portion by a first gap, and
an anchor portion separated at least partially from the piezoelectric actuator support portion by a second gap, the anchor portion configured to be joined to an underlying substrate.

13. The display device of claim 12, wherein the transmission arm is tapered at least in a first segment along a direction from the piezoelectric actuator support portion towards the flexure arm.

14. The display device of claim 13, wherein the transmission arm is tapered in a second segment along a direction from the flexure arm towards the piezoelectric actuator support portion.

15. The display device of claim 12, wherein the controller is configured to energize the piezoelectric film using a drive voltage within a range of 5.0 V to 10.0 V.

16. A scanning mirror system, comprising:
a body comprising
a mirror portion,
a flexure arm extending from the mirror portion,
a piezoelectric actuator support portion supporting a piezoelectric actuator comprising a piezoelectric film,
a transmission arm extending between the flexure arm and the piezoelectric actuator support portion to transmit motion of the piezoelectric film to the flexure arm, the transmission arm comprising a tapered profile in a first segment extending towards the flexure arm, and
an anchor portion separated at least partially from the piezoelectric actuator support portion by a gap, the anchor portion configured to be joined to an underlying substrate.

17. The scanning mirror system of claim 16, wherein the transmission arm further comprises a tapered profile in a second segment extending towards the piezoelectric actuator support portion.

18. The scanning mirror system of claim 17, wherein the gap is a first gap, and the second segment of the transmission arm is at least partially separated from the piezoelectric actuator support portion by a second gap.

19. The scanning mirror system of claim 16, wherein the piezoelectric actuator support portion is configured to match a mode shape of the mirror portion when the mirror portion is oscillating.

20. The scanning mirror system of claim 16, wherein the scanning mirror system comprises a Q factor that is greater than 1100 and less than 25,000.
